(19) United States
(12) Patent Application Publication
(10) Pub. No.: US 2022/0156763 A1
(43) Pub. Date: May 19, 2022

(54) ALLOCATING SEARCH ENGINE MARKETING BUDGET BASED ON MARGINAL RETURN ON ADVERTISEMENT SPEND

(71) Applicant: Walmart Apollo, LLC, Bentonville, AR (US)

(72) Inventors: Changzheng Liu, Sunnyvale, CA (US); Georgios Rovatsos, San Francisco, CA (US); Wei Shen, Pleasanton, CA (US)

(73) Assignee: Walmart Apollo, LLC, Bentonville, AR (US)

(21) Appl. No.: 17/588,250

(22) Filed: Jan. 29, 2022

Related U.S. Application Data
(63) Continuation-in-part of application No. 16/262,485, filed on Jan. 30, 2019.

(51) Int. Cl. G06Q 30/02

(52) U.S. Cl. CPC G06Q 30/0201; G06Q 30/0277; G06Q 30/0273

(57) ABSTRACT

A method including receiving a total budget amount for a predetermined time period. The method also can include determining a respective spend amount for the predetermined time period for each respective node of nodes of a layered allocation tree based a marginal return on advertisement spend (MROAS) value and a respective performance curve for the each respective node. The method additionally can include determining a total spend amount based on the respective spend amounts of the nodes of the layered allocation tree. The method further can include, when the total spend amount is not within a threshold value of the total budget amount, iteratively adjusting the MROAS value to re-determine the respective spend amounts for the nodes and re-determine the total spend amount, based on the MROAS value, as adjusted, until the total spend amount is within the threshold value. The method additionally can include, when the total spend amount is within the threshold value, outputting an allocation for the predetermined time period. The allocation can include the respective spend amounts for the nodes of the layered allocation tree. Other embodiments are described.

### CROSS-REFERENCE TO RELATED APPLICATION

This application is a continuation-in-part of U.S. patent application Ser. No. 16/262,485, filed Jan. 30, 2019. U.S. patent application Ser. No. 16/262,485 is incorporated herein by reference in its entirety.

### TECHNICAL FIELD

This disclosure relates generally to bidding platforms for search engine marketing, and relates more particularly to allocating search engine marketing budget based on marginal return on ad spend.

### BACKGROUND

Search engine marketing (SEM) involves promoting websites in search engine results, often through paid advertising to search engine companies. Types of advertisements in SEM can include product listing advertisements and keyword (textual) advertisements, for example. SEM has become a significant factor in driving web traffic to various websites. Allocating resources for SEM can involve many decisions and tradeoffs, and it can be challenging to control for allocation and performance objectives.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a performance bidding system that can be employed for providing a bidding platform with controls for multiple objectives, according to an embodiment;

FIG. 4 illustrates a flow chart for a method, according to an embodiment;

FIG. 5 illustrates an exemplary user interface display to allow a user to provide input to the performance bidding system of FIG. 3 to display output to the user;

FIG. 6 illustrates an exemplary user interface display to allow a user to view performance results using the performance bidding system of FIG. 3;

FIG. 7 illustrates a graph of an ad spend versus revenue curve at a super department level;

FIG. 8 illustrates a flow chart for a method, according to another embodiment;

FIG. 9 illustrates a graph showing two different exemplary performance curves;

FIG. 10 illustrates a graph showing a performance curve that was generated based on historical SEM performance data;

FIG. 11 illustrates a flow chart for a method, according to another embodiments; and

FIG. 12 illustrates an exemplary layered allocation tree.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

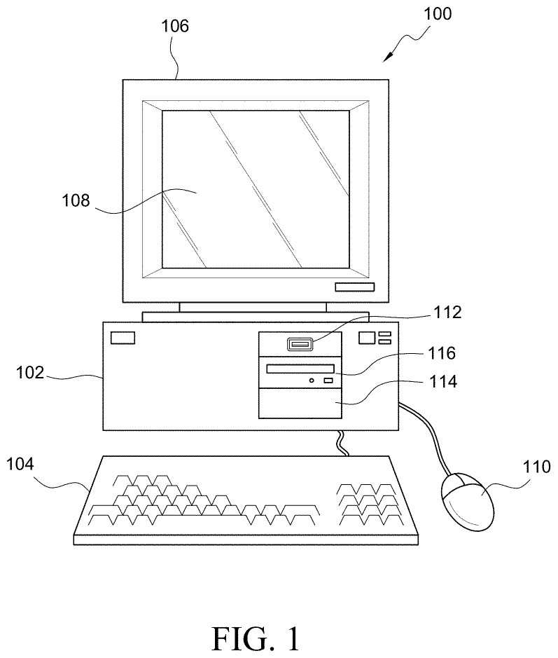

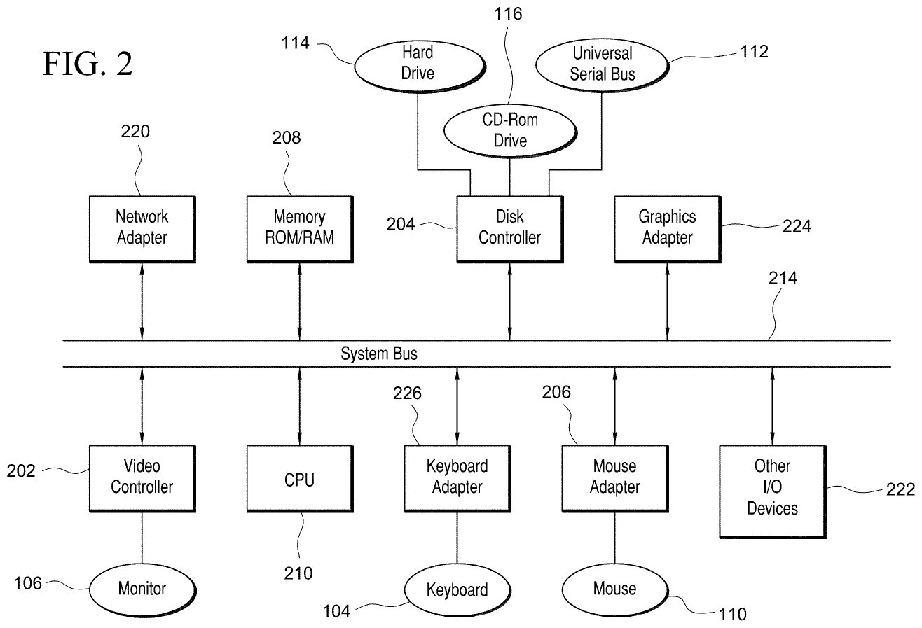

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

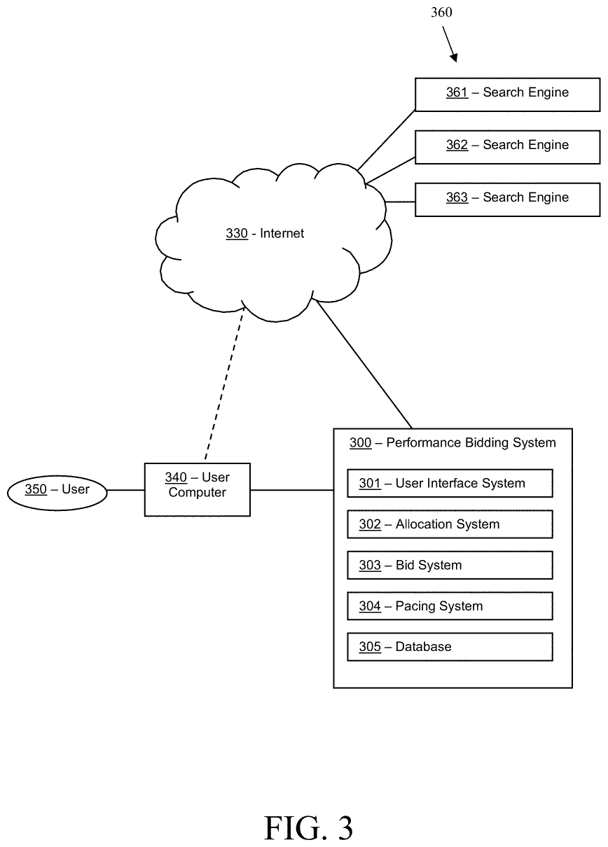

Turning ahead in the drawings, FIG. 3 illustrates a block diagram of a performance bidding system 300 that can be employed for providing a bidding platform with controls for multiple objectives and/or allocating search engine marking budget based on marginal return on advertisement spend, according to an embodiment. Performance bidding system 300 is merely exemplary, and embodiments of the system are not limited to the embodiments presented herein. The system can be employed in many different embodiments or examples not specifically depicted or described herein. In some embodiments, certain elements, modules, or systems of performance bidding system 300 can perform various procedures, processes, and/or activities. In other embodiments, the procedures, processes, and/or activities can be performed by other suitable elements, modules, or systems of performance bidding system 300. Performance bidding system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of performance bidding system 300 described herein.

In many embodiments, performance bidding system 300 can include a user allocation system 301, an allocation system 302, a bid system 303, a pacing system 304, and/or a database 305. In many embodiments, the systems of performance bidding system 300 can be modules of computing instructions (e.g., software modules) stored at non-transitory computer readable media that operate on one or more processors. In other embodiments, the systems of performance bidding system 300 can be implemented in hardware. Performance bidding system 300 can be a computer system, such as computer system 100 (FIG. 1), as described above, and can be a single computer, a single server, or a cluster or collection of computers or servers, or a cloud of computers or servers. In another embodiment, a single computer system can host performance bidding system 300. Additional details regarding performance bidding system 300 and the components thereof are described herein.

In some embodiments, performance bidding system 300 can be in data communication directly or through Internet 330 with one or more user computers, such as user computer 340. In some embodiments, user computer 340 can be used by users, such as user 350. In many embodiments, performance bidding system 300 can host a website, an application, or another form of graphical user interface. For example, performance bidding system 300 can host a website that allows users, such as business managers or marketing managers, to manage bidding for SEM. In many embodiments, an internal network that is not open to the public can be used for communications between performance bidding system 300 and user computer 340. In other embodiments, user computer 340 can access performance bidding system 300 through Internet 330.

In certain embodiments, user computers (e.g., 340) can be desktop computers, laptop computers, a mobile device, and/or other endpoint devices used by users (e.g., 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can include the Virtual Retinal Display™ product, or similar product by the University of Washington of Seattle, Wash., United States of America. Meanwhile, in further specific examples, a limb mountable wearable user computer device can include the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In many embodiments, performance bidding system 300 can include one or more input devices (e.g., one or more keyboards, one or more keypads, one or more pointing devices such as a computer mouse or computer mice, one or more touchscreen displays, a microphone, etc.), and/or can include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to performance bidding system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of performance bidding system 300. In a similar manner, the processors and/or the non-transitory computer-readable media can be local and/or remote to each other.

Meanwhile, in many embodiments, performance bidding system 300 also can be configured to communicate with and/or include one or more databases, such as database 305, and/or other suitable databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between performance bidding system 300 and the one or more databases can be implemented using any suitable manner of wired and/or wireless communication. Accordingly, performance bidding system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In several embodiments, performance bidding system 300 can be in data communication through Internet 330 with search engines 360, which can include search engine 361-363, for example. For example, search engine 361 can be the Google search engine, search engine 362 can be the Yahoo search engine, and search engine 363 can be the Bing search engine. In many embodiments, search engines 360 each can provide SEM services, such as product listing advertisements and/or keyword (e.g., text) advertisements (branded and non-branded). These advertisements can be displayed along with or as part of search results provided by search engines 360 to users of search engines 360. In many embodiments, these advertisements can be used to drive web traffic to a website, such as an e-commerce website. SEM has become a major marketing vehicle for many retailers. For example, a retailer can have more than 67 million products listing advertisements and 90 million keyword advertisements on the Google, Bing, Yahoo search engines (e.g., 361-363), which can create 550 million possible impression opportunities per day.

Budget allocation can be an aspect of SEM business financial planning. In some conventional approaches, a portfolio approach has been used to manage budget. For example, a total budget was set at the beginning of a month for all divisions and the actual advertising spending (“ad spend”) was verified by the end of a month. Under such an approach, there can be a lack of guidelines for budget allocation among each division and subdivision (e.g., super department). In some approaches, a key performance indicator (KPI) can be applied to the overall budget to assess performance.

In several embodiments, performance bidding system 300 can allow a user (e.g., 350), such as a marketing manager, to set a budget allocation amount (e.g., ad spend) at a division or subdivision (e.g., super department, department, or category) level. In a number of embodiments, performance bidding system 300 can provide the user (e.g., 350) with a forecast on how the ad spend specified will impact performance over time, based on KPIs or other performance indicators. In some embodiments, performance bidding system 300 can allocate the budget based on the KPI specified from the user (e.g., 350). For example, the budget can be allocated on a 7-day rolling model, a 14-day rolling model, or on another suitable time frame.

In many embodiments, forecasts of how the ad spend specified will impact performance over time can assist users (e.g., 350), such as business partners, when they perform a budget plan. For example, the forecasts can provide guidance of how much budget to allocate in certain divisions or subdivisions in order to achieve a certain KPI. For example, a business partner can have a budget of $200,000 for the Fashion division for the next 7 days and can desire a performance output of 5.0 for return on ad spend (ROAS). The budget can be entered into performance bidding system 300, and a ROAS range of 3.06 to 4.14 can be displayed, indicating that a ROAS of 5.0 would exceed the forecast for that budget. Accordingly, the amount of budget allocated to Fashion can be decreased in order to meet the ROAS goal of 5.0.

In several embodiments, performance bidding system 300 can allocate SEM budget based on marginal return on advertisement spend (MROAS). MROAS is the slope (i.e., derivative) of the ROAS curve. In many embodiments, the MROAS can be equalized across search engine types, product divisions, and/or advertisement types. For example, if $6 million is allocated to spend in SEM on Black Friday, the allocation across search engines, ad types, and product divisions can be such that the MROAS is equalized in each case. MROAS can equalized in each category of search engines, product divisions, and advertisement types instead of ROAS in some embodiments, because equalizing MROAS makes it so, at the margin, there is not a desire to spend more on one category over another.

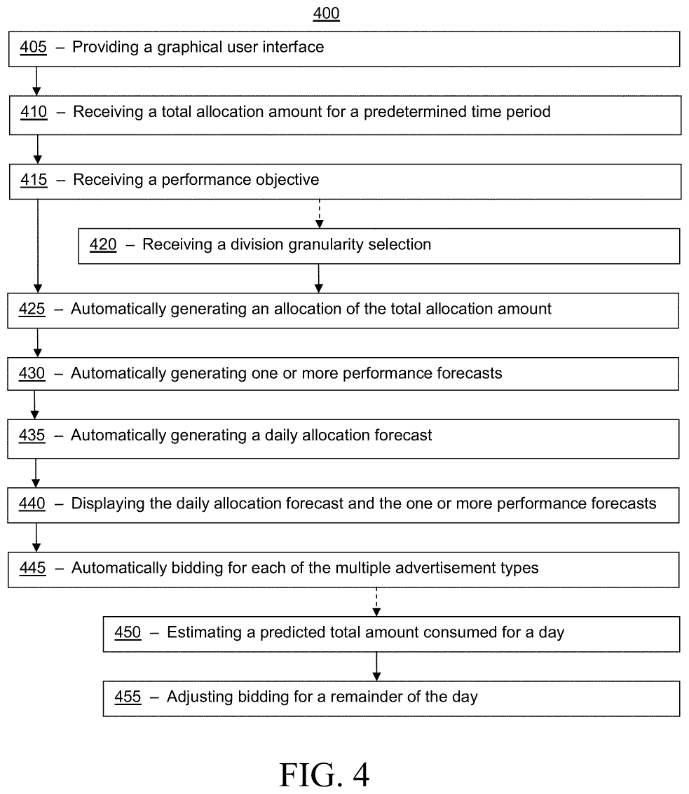

Turning ahead in the drawings, FIG. 4 illustrates a flow chart for a method 400. In some embodiments, method 400 can be a method of providing a bidding platform with controls for multiple objectives and/or allocating search engine marking budget based on marginal return on advertisement spend. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, performance bidding system 300 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as performance bidding system 300 (FIG. 3). The processor(s) can be similar or identical to the processor(s) described above with respect to computer system 100 (FIG. 1).

In some embodiments, method 400 and other blocks in method 400 can include using a distributed network including distributed memory architecture to perform the associated activity. This distributed architecture can reduce the impact on the network and system resources to reduce congestion in bottlenecks while still allowing data to be accessible from a central location.

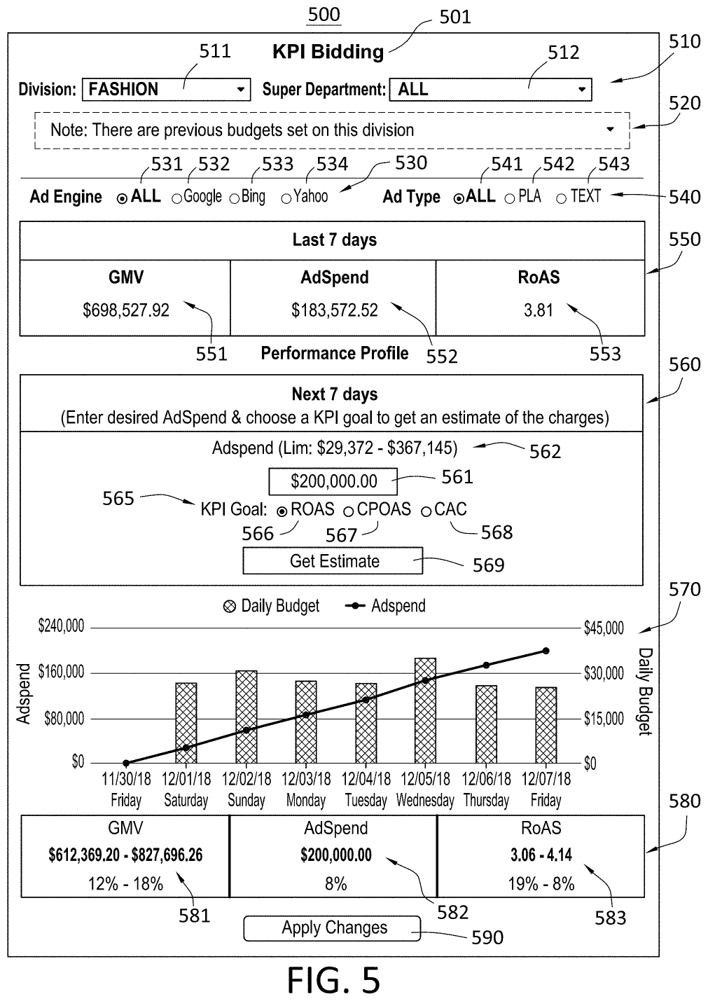

Referring to FIG. 4, method 400 can include a block 405 of providing a graphical user interface comprising input fields and output fields. In many embodiments, the graphical user interface can be similar or identical to user interface display 500, as shown in FIG. 5 and described below.

Turning ahead in the drawings, FIG. 5 illustrates an exemplary user interface display 500 to allow a user (e.g., 350 (FIG. 3)) to provide input to performance bidding system 300 (FIG. 3) to display output to the user. User interface display 500 is merely exemplary, and embodiments of the user interface display are not limited to the embodiments presented herein. The user interface display can be employed in many different embodiments or examples not specifically depicted or described herein, and can include other suitable elements. In many embodiments, performance bidding system 300 (FIG. 3) can provide an interface on user device 340 (FIG. 3), and the interface can display user interface display 500.

In a number of embodiments, user interface display 500 can include a title bar 501, division granularity input fields 510, a previous allocation information field 520, search engine selection fields 530, ad type selection fields 540, previous week information display fields 550, next week input fields 560, daily allocation forecast display 570, performance forecast display fields 580, apply button 590, and/or other suitable fields or elements. In many embodiments, title bar 501 can indicate include the name of the user interface or portion thereof.

In several embodiments, division granularity input fields 510 can include a division selection field 511, a super department selection field 512, and/or other suitable selection fields. For example, in some embodiments, divisional granularity input fields 510 can include selection fields (e.g., 511-512) for selecting various divisions and/or subdivisions of a company and/or enterprise, such as a division, a super department, a department, a category, etc., or to select all divisions. For example, as shown in FIG. 5, a user (e.g., 350 (FIG. 3)) can use divisional granularity input fields 510 to specify the division granularity to apply when inputting and/or displaying information in user interface display 500. For example, as shown in FIG. 5, a user (e.g., 350 (FIG. 3)) can specify, using division selection field 511, that the inputs and displays in user interface display 500, and/or the bidding specified using user interface display 500, will apply to the Fashion division, and can specify, using super department selection field 512, that all super departments within the Fashion division apply. In many embodiments, the options available to select within super department selection field can be based on the division selected using division selection field 511.

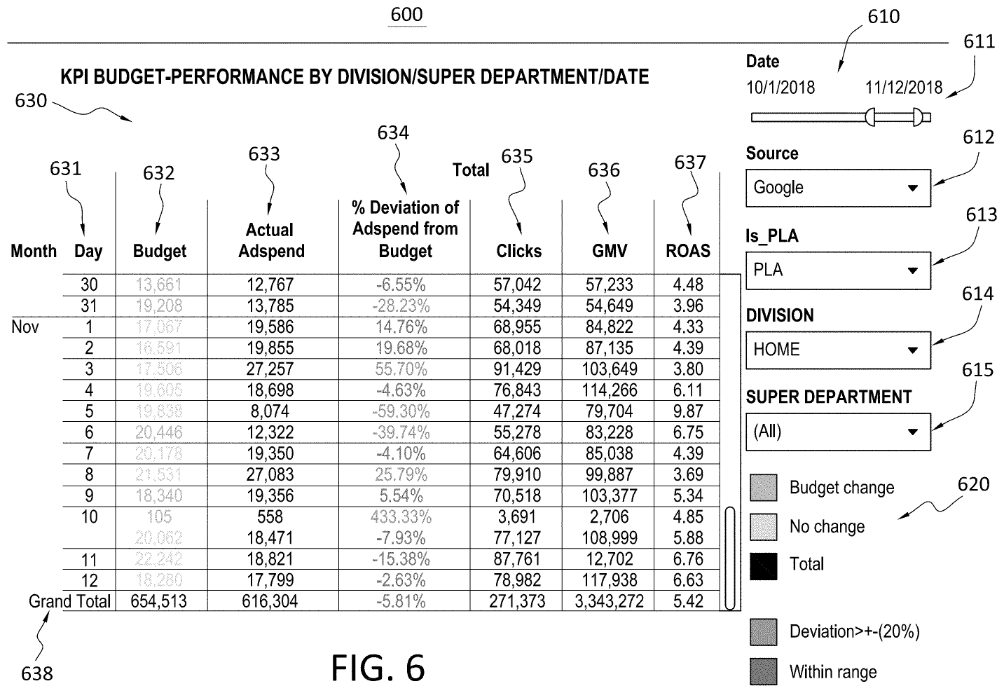

In some embodiments, when the divisions and/or subdivisions selected have historical budget information, such as based on previous budget allocations, previous allocation information field 520 can display a notification that previous budgets have been set for the division and/or super department selected. In some embodiments, a user (e.g., 350 (FIG. 3)) can click on previous allocation information field 520 to display information about the previous budget allocations, and/or performance results, such as shown in user interface display 600, as shown in FIG. 6 and described below.

In several embodiments, search engine selection fields 530 can include search engine selection options, such as an all selection 531, a Google selection 532, a Bing selection 533, a Yahoo selection 534, and/or other suitable search engine selection options. In a number of embodiments, a user (e.g., 350 (FIG. 3)) can select one of the search engine selection options (e.g., 531-534) to specify the search engine to apply when inputting and/or displaying information in user interface display 500. For example, as shown in FIG. 5, a user (e.g., 350 (FIG. 3)) can select all selection 531 to specify that the inputs and displays in user interface display 500, and/or the bidding specified using user interface display 500, will apply to, and/or be based on, all of the search engine options available.

In many embodiments, ad type selection fields 540 can include ad type selection options, such as an all selection 541, a PLA (product listing advertisement) selection 542, a textual (keyword) selection 543, and/or other suitable ad type selection options. In a number of embodiments, a user (e.g., 350 (FIG. 3)) can select one of the ad type selection options (e.g., 541-543) to specify the advertisement type to apply when inputting and/or displaying information in user interface display 500. For example, as shown in FIG. 5, a user (e.g., 350 (FIG. 3)) can select all selection 531 to specify that the inputs and displays in user interface display 500, and/or the bidding specified using user interface display 500, will apply to, and/or be based on, all of the ad type options available, such as both PLAs and textual (keyword) advertisements.

In some embodiments, previous week information display fields 550 can display information about, and/or performance results for, the previous week for the combination of division (if applicable), super department (if applicable), search engine option, and ad type option, based on the selections in division granularity input fields 510, search engine selection fields 530, and ad type selection fields 540. In a number of embodiments, previous week information display fields 550 can include a GMV (gross merchandise volume) field 551, an ad spend field 552, a performance result field 553, and/or other suitable fields. For example, ad spend field 552 can display that $183,572.52 was spent on SEM bidding during the previous week for the Fashion division (and all super departments therein), for all search engines, and for all ad types; GMV field 551 can display that $698,527.92 was the gross merchandise volume for the previous week for the Fashion division (and all super departments therein), for all search engines, and for all ad types; and performance result field 553 can display that the ROAS is 3.81 based on these numbers over the previous week for the Fashion division (and all super departments therein), for all search engines, and for all ad types. This data and other data shown in FIGS. 5-6 can be exemplary data for illustrative purposes only. In the same or other embodiments, other or additional performance results can be displayed in performance result field 553. For example, contribution profit on ad spend (CPOAS), cost per acquired customer (CAC), and/or other suitable performance metric can be used to display performance results in performance result field 553. In some embodiments, the MROAS can be displayed.

In many embodiments, next week input fields 560 can allow a user (e.g., 350 (FIG. 3)) to input objectives for the following week and display constraints on one or more inputs. In several embodiments, next week input fields 560 can include an ad spend selection button 561, an ad spend constraint display field 562, performance objective selection fields 565, an estimate button 569, and/or other suitable fields or elements. In a number of embodiments, ad spend selection button 561 can be used to enter an amount to spend for SEM advertisements in the next week, based on the combination of division (if applicable), super department (if applicable), search engine option, and ad type option, based on the selections in division granularity input fields 510, search engine selection fields 530, and ad type selection fields 540. For example, as shown in FIG. 5, a user (e.g., 350 (FIG. 3)) can use ad spend selection button 561 to select to spend $200,000.00 during the next week for the Fashion division (and all super departments therein), for all search engines, and for all ad types. In many embodiments, the ad spend amount that can be entered using ad spend selection button 561 can be constrained by lower and/or upper bounds, which can be displayed in ad spend constraint display field 562. As described below in further detail, the constraints can prevent a user (e.g., 350 (FIG. 3)) from entering an ad spend amount that is far less or far exceeds the ad spend for the previous week and/or the historical ad spend.

In a number of embodiments, performance objective selection fields 565 can include performance objective selection options, such as a ROAS performance objective selection 566, a CPOAS performance objective selection 567, a CAC performance objective selection 568, and/or other suitable performance objective selections. In several embodiments, a user (e.g., 350 (FIG. 3)) can select one of the performance objective selection options (e.g., 566-568) to specify the performance objective to apply when allocating budgets and/or generating forecasts. For example, as shown in FIG. 5, a user (e.g., 350 (FIG. 3)) can select ROAS performance objective selection 566 to specify that the performance objective used for allocation and/or forecasting will be ROAS. In some embodiments, the MROAS also can be selected as the performance objective, and/or selecting ROAS as the performance objective can result in equalizing the MROAS.

In several embodiments, once the ad spend has been entered in ad spend selection button 561 and the performance objective has been selected in performance objective selection fields 565, a user (e.g., 350 (FIG. 3)) can select estimate button 569 to generate an allocation and/or forecast, which are displayed in daily allocation forecast display 570 and/or performance forecast display fields 580, described below.

In several embodiments, daily allocation forecast display 570 can display a forecast of ad spending for each day of the upcoming week, as shown as a bar graph in daily allocation forecast display 570 in FIG. 5, and/or a forecast of a cumulative amount spent after each day of the upcoming week, as shown as a line graph in daily allocation forecast display 570 in FIG. 5.

In many embodiments, performance forecast display fields 580 can display information about budgets and/or forecasted results for the upcoming week for the combination of division (if applicable), super department (if applicable), search engine option, and ad type option, based on the selections in division granularity input fields 510, search engine selection fields 530, and ad type selection fields 540, and/or based on the ad spend selected in ad spend selection button 561 and/or the performance objective selected in performance objective selection fields 565. In a number of embodiments, performance forecast display fields 580 can include a forecasted GMV field 581, a budgeted ad spend field 582, a performance forecast field 583, and/or other suitable fields. For example, budgeted ad spend field 582 can display that $200,000.00 is budgeted to be spent on SEM bidding during the upcoming week for the Fashion division (and all super departments therein), for all search engines, and for all ad types; forecasted GMV field 581 can display that the gross merchandise volume for the upcoming week for the Fashion division (and all super departments therein), for all search engines, and for all ad types is forecasted to be in the range of $612,369.20 to $827,696.26; and performance forecast field 583 can display that the ROAS is forecasted to be in the range of 3.06 to 4.14 for the upcoming week for the Fashion division (and all super departments therein), for all search engines, and for all ad types. In some embodiments, the MROAS can be displayed. In the same or other embodiments, other or additional forecasted performance results can be displayed in performance forecast field 583. For example, CPOAS, CAC, and/or other suitable performance metric can be used to display forecasted performance results in performance forecast field 583. In many embodiments, performance forecast field 583 can include performance forecasts for at least the performance objective selected in performance objective selection fields 565.

In several embodiments, after a user (e.g., 350 (FIG. 3)) has reviewed the estimate provided in daily allocation forecast display 570 and/or performance forecast display fields 580, and made any further adjustments desired by the user, the user can select apply button 590 to apply the selections made in user interface display 500 for the SEM bidding in the upcoming week.

Returning to FIG. 4, in several embodiments, method 400 also can include a block 410 of receiving a total allocation amount for a predetermined time period in an allocation amount input field of the input fields of the graphical user interface. The allocation amount input field can be similar or identical to ad spend selection button 561 (FIG. 5). In some embodiments, the predetermined time period can be a week, such as the upcoming seven days. In other embodiments, the predetermined time period can be another suitable time period, such as a day, two days, three days, four days, five days, six days, two weeks, three weeks, four weeks, or a month, for example. For example, the total allocation amount can be the amount entered in ad spend selection button 561 (FIG. 5), which can be the amount budgeted for ad spend over the upcoming seven days. In some embodiments, the total allocation amount can be set for the total enterprise, per division, or per subdivision (e.g., super department).

In several embodiments, the allocation amount input field can constrain the total allocation amount between a lower bound and an upper bound based on a previous allocation amount. For example, the lower bound and/or upper bound can be displayed in ad spend constraint display field 562 (FIG. 5). In some embodiments, the previous allocation amount can be the total allocation amount budgeted for ad spend during the previous seven days, such as displayed in ad spend field 552. In other embodiments, the previous allocation amount can be the total allocation amount budgeted historically in any previous predetermined time period (e.g., seven-day time period) for the past month, the past year, or since budgets have been set for the applicable division and/or super department selected, if any. In some embodiments, the lower bound can be approximately 20% of the previous allocation amount and/or the upper bound can be approximately 200% of the previous allocation amount. In other embodiments, the lower bound and/or upper bound can be another percentage of the previous allocation amount and/or historical allocation amounts. In some embodiments, the total allocation amount can be constrained to a range that will allow a forecast prediction to be made for the performance objective. For example, a sudden increase of budget by 500% can be rejected, as the performance objective can be difficult to forecast without historical performance information being within a range of or the total allocation amount in which forecasts can be extrapolated to provide performance guidance.

In a number of embodiments, method 400 additionally can include a block 415 of receiving a performance objective in a performance objective input field of the input fields of the graphical user interface. The performance objective input field can be similar or identical to performance objective selection fields 565 (FIG. 5). In several embodiments, the performance objective input field can provide a set of options for selection of the performance objective. For example, the set of options can be similar or identical to ROAS performance objective selection 566 (FIG. 5), CPOAS performance objective selection 567 (FIG. 5), and/or CAC performance objective selection 568 (FIG. 5). In many embodiments, the performance objective can be a KPI, such as ROAS, CPOAS, CAC, MROAS, or another suitable KPI.

In some embodiments, method 400 optionally can include a block 420 of receiving a division granularity selection in one or more division granularity fields of the input fields of the graphical user interface. The division granularity input fields can be similar or identical to division granularity input fields 510 (FIG. 5). For example, the division granularity selection can be a division selected in division selection field 511 (FIG. 5) and/or a subdivision (e.g., super department) selected in super department selection field 512 (FIG. 5). In some cases, the division and/or super department selected can be similar or identical “all” divisions and/or super departments or a specific division or super department. For example, the Fashion division and all super departments thereunder can be selected, as shown in FIG. 5.

In several embodiments, method 400 further can include a block 425 of automatically generating an allocation of the total allocation amount among combinations selected from multiple advertisement types and multiple search engines based at least in part on the total allocation amount and the performance objective according to allocation balancing rules. For example, the total allocation amount can be allocated to different search engine and ad type combinations. For example, a first amount of the total allocation amount can be allocated to product listing ads on the Google search engine, a second amount of the total allocation amount can be allocated to textual ads on the Google search engine, a third amount of the total allocation amount can be allocated to product listing ads on the Bing search engine, a fourth amount of the total allocation amount can be allocated to textual ads on the Bing search engine, a fifth amount of the total allocation amount can be allocated to product listing ads on the Yahoo search engine, a sixth amount of the total allocation amount can be allocated to textual ads on the Yahoo search engine. In some embodiments, the allocation balancing rules can include allocating amounts to equalize predicted performance under the performance objective in each of the combinations selected from multiple advertisement types and multiple search engines. For examples, if ROAS is selected as the performance objective, the amount allocated to each of the combinations of search engines and ad types can be set to achieve the desired ROAS in each of these combinations, which can involve allocating more of the budget to certain combinations and less to others. In other embodiments, MROAS can be equalized across the combinations, as described below in further detail.

In several embodiments, such as when a division granularity selection is provided in block 420, block 425 can include automatically allocating between subdivisions of the division granularity selection based at least in part on the total allocation amount and the performance objective according to the allocation balancing rules. In some embodiments, the allocation balancing rules can include allocating amounts that equalize predicted performance under the performance objective in each of the combinations selected from multiple advertisement types and multiple search engines in each of the subdivisions. For example, if the division is set to Fashion and the super department to all, as shown in FIG. 5, the total allocation amount can be allocated among each of the super departments under the Fashion division within each of the combinations of search engines and ad types in a way that is set to achieve the desired ROAS or MROAS in each of these combinations of super departments, search engines, and ad types. For example, if spending $1,000 in super department B yields revenue of $10,000, and spending $1,000 in super department A yields $5,000 of revenue, then more of the budget can be allocated to super department B in order to equalize performance, as estimated based on past empirical data.

In many embodiments, the total allocation amount can be allocated to each super department, search engine, and ads type combination according to historical revenue performance to equalize predicted performance under the performance objective (e.g., ROAS) across the different super departments of the division. In other words, for super departments A and B, it can be desired that ROAS_{A}=ROAS_{B}, such that:

$$ROA {S}_{A} = \frac{r e v e n u {e}_{A}}{ad {spend}_{A}} = ROA {S}_{B} = \frac{r e v e n u {e}_{B}}{ad {spend}_{B}} ⇒ \frac{ad {spend}_{A}}{ad {spend}_{B}} = \frac{r e v e n u {e}_{A}}{r e v e n u {e}_{B}} .$$

In many embodiments, different budget allocations in each super department, search engine, and/or ad type combination can be used to achieve different bidding efficiency. Different weighted linear models can be generated for each super department, search engine, and ad type combination. For example, a model can be built to a seven-day ad spend (spd) and seven-day revenue (r), based on elasticity principles, in the form of:

r=β₀spd^{β}^{₁},

which can be linearized using log linearization as follows:

log(r)=log(spd)+log(β₀),

where β₀ and β₁ are coefficients for each model that are derived based on the historical performance to fit the curve in the model to the actual historical performance.

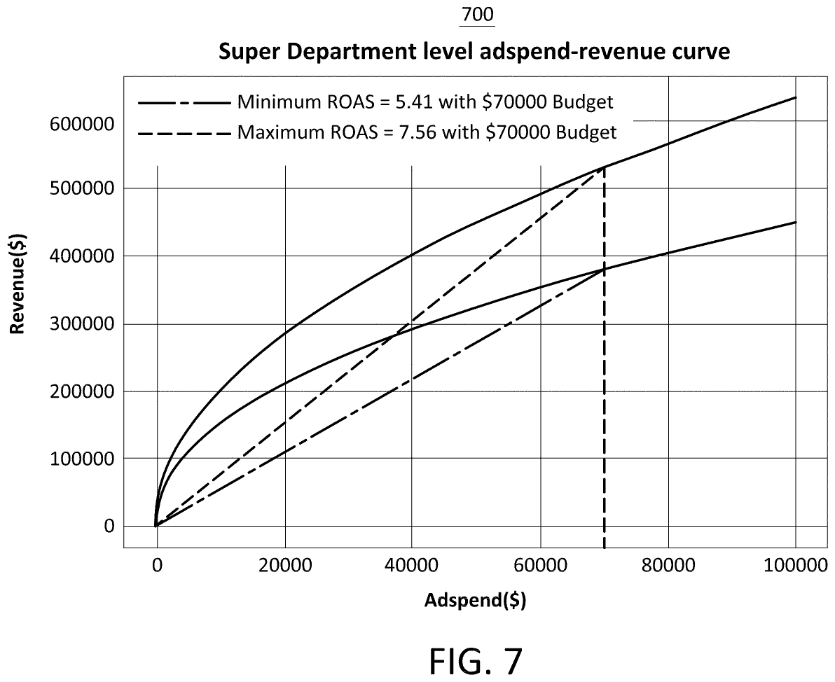

Jumping ahead in the drawings, FIG. 7 illustrates a graph 700 of an ad spend versus revenue curve at a super department level. As shown in FIG. 7, when allocating a budget of $70,000 to a super department, historical performance indicates that ROAS would be between 5.41 and 7.56. Generally, revenue would be within the range of the upper and lower curves, based on different ad spend values. Based on elasticity principles, including diminishing returns, the ROAS will decrease as ad spending increases.

In many embodiments, the data for used for developing each model can be based on data that is aggregated by week to exclude effects for different days of the week. In several embodiments, for each model, the most recent two-month data and the same three-month period from the previous year can be used and aggregated by week. For example, to predict the revenue in the week of Sep. 3, 2018 to Sep. 9, 2018, aggregated features can be used from July 2018 to August 2018, and from August 2017 to October 2017. Different weights (wᵢ) can be assigned to the data for this year and last year to build the models. For example, the data for this year can be weighted at 0.3, and the data for last year can be weighted at 0.2 for typical (non-holiday) seasons, while the data for this year can be weighted at 0.3 and the data for last year can be weighted at 0.7 for last year for holiday seasons, as the performance during the holiday season last year can be more relevant to predicted performance during this holiday season than the sales from the past months this year, but during non-holiday seasons, the last two months can be more predicted than the performance last year. In other embodiments, other weights can be used. The solution can be determined by minimizing the weighted sum of squares:

$${argmin}_{w , β} {\sum }_{i = 1}^{n} {w}_{i} {\vert log ( {r}_{i} ) - {β}_{1} log ( spd ) - log ( {β}_{0} ) \vert}^{2} ,$$

where wᵢ>0 is the weight of i^{th} observation. In many embodiments, with a specified seven-day budget, the model can predict a range of seven-day revenue within a 90% confidence interval.

Returning to FIG. 4, in a number of embodiments, method 400 additionally can include a block 430 of automatically generating one or more performance forecasts based on the allocation. In many embodiments, the one or more performance forecasts can include predicted ranges based at least in part on historical performance data. For example, the performance forecasts can include GMV, ROAS, CPOAS, CAC, MROAS, and/or other suitable performance forecasts, which can be forecasted using the revenue predicted in the allocation generated in block 425. In several embodiments, each of these forecasts can include a range predicted by historical performance.

In several embodiments, method 400 further can include a block 435 of automatically generating a daily allocation forecast across the predetermined time period based on the allocation. In some embodiments, the allocation generated in block 425 can be allocated to each day of the upcoming week based on day-of-week effect, such that certain days of the week receive more of the budget than other days of the week. For example, certain days of the week can generally have higher performance than other days of the week, and the amount allocated to each day can be adjusted to equalize the performance objective (e.g., ROAS, MROAS, etc.), or based on user input.

In a number of embodiments, method 400 additionally can include a block 440 of displaying the daily allocation forecast and the one or more performance forecasts in the output fields of the graphical user interface. For example, the daily allocation forecast can be displayed in daily allocation forecast display 570 (FIG. 5), and the performance forecasts can be displayed in performance forecast display fields 580 (FIG. 5). In several embodiments, the daily allocation forecast displayed in at least one of the output fields of the graphical user interface can include a daily allocation amount for each day of the predetermined time period a cumulative allocated amount for each day of the predetermined time period. For example, as shown in daily allocation forecast display 570 (FIG. 5), a spending distribution graph can be displayed to depict how the ad spend will be distributed in the next 7 days, and a cumulative ad spend can be shown starting from 0 to the forecasted target ad spend by day 7.

In several embodiments, method 400 further can include, after receiving an approval, a block 445 of automatically bidding for each of the multiple advertisement types at each of the multiple search engines based at least in part on the daily allocation forecast. For example, after the daily allocation forecast and the one or more performance forecasts are displayed to the user (e.g., 350 (FIG. 3)), the user can approve the allocation and forecasts, such as by clicking the apply button 590 (FIG. 5). In several embodiments, bids can be generated using conventional approaches, but based on the allocation generated and approved. For example, bids for each product listing advertisement and textual advertisement can be generated based on SEM predicted signals and the forecast performance objective. The SEM predicted signals can be information such as revenue per click, which can be received by performance bidding system 300 (FIG. 3) and/or generated in a conventional manner by performance bidding system 300 (FIG. 3) from another system. In many embodiments, the bid generation can be done conventionally based on the SEM predicted signals, but can based on the budget allocated among the different combinations, as described above.

For example, in many embodiments, different models for the specified performance objective can be built, such as random forest models, XGBoost models, or other suitable models, to predict signals to generate bids in order to achieve the desired performance objective. Using a performance objective of ROAS, for example, with the forecasted ROAS, each bid can be set based on its predicted revenue per click (rpc), as follows:

$$b i {d}_{i} ∝ \frac{{rpc}_{i}}{ROA {S}_{i}}$$

In several embodiments, once the bids are set, they can be sent to the search engines for the bid amounts determined.

In a number of embodiments, block 445 can include a block 450 of estimating a predicted total amount consumed for a day based on actual amounts consumed during a first portion of the day and historical amounts consumed. In several embodiments, the estimate of the predicted total amount consumer can be used for ad spend pacing control, as provided in blocks 450 and 455 (described below). Often times, the traffic demand pattern can be similar between today and yesterday and last week on the same day of the week. For each super department, the ad spend for the first four hours (or another suitable number of hours) of today can be compared with the ad spend data from yesterday and last week on the same day of the week. With total ad spend for those two days, the projected ad spend can be predicted today.

In some embodiments, the predicted total amount consumed for the day (e.g., today) can be estimated using the following formula:

$${S}_{T} = \frac{{\sum }_{i = 1}^{H} {S}_{i T}}{{\sum }_{i = 1}^{H} {S}_{i Y}} * {S}_{Y} ,$$

where S_{T} is the ad spend for today, S_{Y} is the ad spend for yesterday, H is the available hourly ad spend at the time of the pacing control job, and sᵢ is the hourly ad spend at i^{th} hour.

In several embodiments, block 445 also can include a block 455 of adjusting bidding for a remainder of the day based on the predicted total amount consumed for the day and an allotment for the day in the daily allocation forecast. For example, if the predicted total amount consumed for the day exceeds the allotment for the day in the daily allocation forecast, adjustments can be made to bids. In some embodiments, pacing control jobs can be run throughout the day at specified times to make adjustments through the day, such as at 6 am on a daily basis, and a second round of pacing adjustment jobs will be submitted if necessary with similar process at 11 am, for example. Blocks 445, 450, and/or 455 can be performed not only automatically, but also in real-time throughout the day so that performance bidding system 300 (FIG. 3) stays within the allotment for that same day.

Jumping ahead in the drawings, FIG. 6 illustrates an exemplary user interface display 600 to allow a user (e.g., 350 (FIG. 3)) to view performance results using performance bidding system 300 (FIG. 3). User interface display 600 is merely exemplary, and embodiments of the user interface display are not limited to the embodiments presented herein. The user interface display can be employed in many different embodiments or examples not specifically depicted or described herein, and can include other suitable elements. In many embodiments, the interface provided by performance bidding system 300 (FIG. 3) on user device 340 (FIG. 3) can display user interface display 600.

In a number of embodiments, user interface display 600 can include selector fields 610, key 620, and output area 630. In several embodiments, input fields 610 can include date range selector 611, search engine selector 612, ad type selector 613, division selector 614, subdivision selector 615, and/or other suitable selectors. In several embodiments, a user (e.g., 350 (FIG. 3)) can select a date range using date range selector 611, one or more search engines using search engine selector 612, one or more ad types using ad type selector 613, one or more divisions using division selector 614, and one or more subdivisions (e.g., super departments) using subdivision selector 615, in order to set the parameters for the data displayed in output area 630.

In some embodiments, output area 630 can display data that shows the details about the amounts allocated and the performance. For example, output area 630 can include a day column 631, to display information on a daily basis, a budget column 632 to display the amount budgeted for each day, an actual ad spend column 633 to display the actual amount spend for each day, a percentage deviation column 634 to display the percentage in which the actual ad spend in actual ad spend column 633 deviated from the budgeted ad spend in budget column 632, a clicks column 635 to display the number of clicks for each day, a GMV column 636 to display the GMV for each day, a performance objective column 637, to display the results for the performance objective (e.g., ROAS, MROAS, etc.) for each day. In several embodiments, output area 630 can include a grand total row 638, which can display the totals in each column for the date range selected in date range selector 611.

In a number of embodiments, the data in output area 630 can be color-coded, shaded, or otherwise coded to provide additional information, as described by key 620. For example, whether the budget was changed or not can be indicated using the coding in budget column 632, and whether the deviation was within a predetermined range (e.g., 20%, or another suitable range) can be indicated using the coding in percentage deviation column 634.

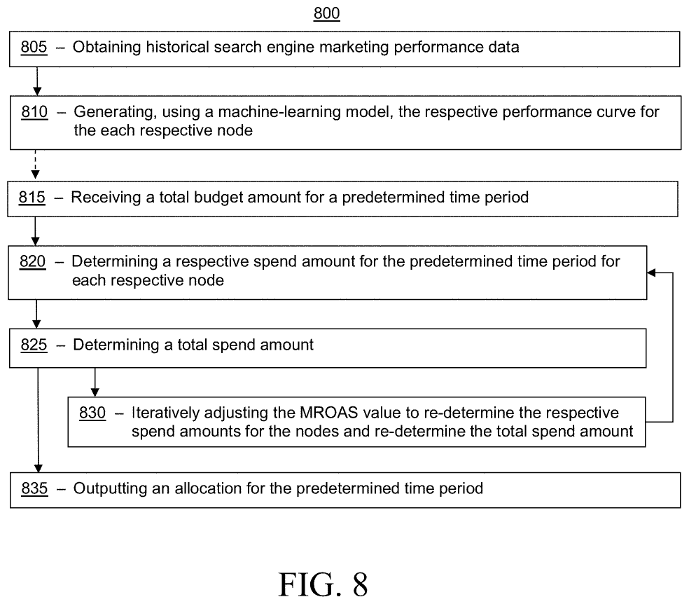

Turning ahead in the drawings, FIG. 8 illustrates a flow chart for a method 800. In some embodiments, method 800 can be a method of allocating search engine marking budget based on marginal return on advertisement spend. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped.

In many embodiments, performance bidding system 300 (FIG. 3) can be suitable to perform method 800 and/or one or more of the activities of method 800. In these or other embodiments, one or more of the activities of method 800 can be implemented as one or more computing instructions configured to run at one or more processors and configured to be stored at one or more non-transitory computer readable media. Such non-transitory computer readable media can be part of a computer system such as performance bidding system 300 (FIG. 3). The processor(s) can be similar or identical to the processor(s) described above with respect to computer system 100 (FIG. 1).

In some embodiments, method 800 and other blocks in method 800 can include using a distributed network including distributed memory architecture to perform the associated activity. This distributed architecture can reduce the impact on the network and system resources to reduce congestion in bottlenecks while still allowing data to be accessible from a central location.

Referring to FIG. 8, method 800 optionally can include a block 805 of obtaining historical search engine marketing performance data. For example, the historical SEM performance data can include information about how much was spent on SEM ads and how much GMV was derived from such spending. This performance data can be across all categories (e.g., search engine types, product divisions, advertisement types), and can be granular within each category and/or category combination.

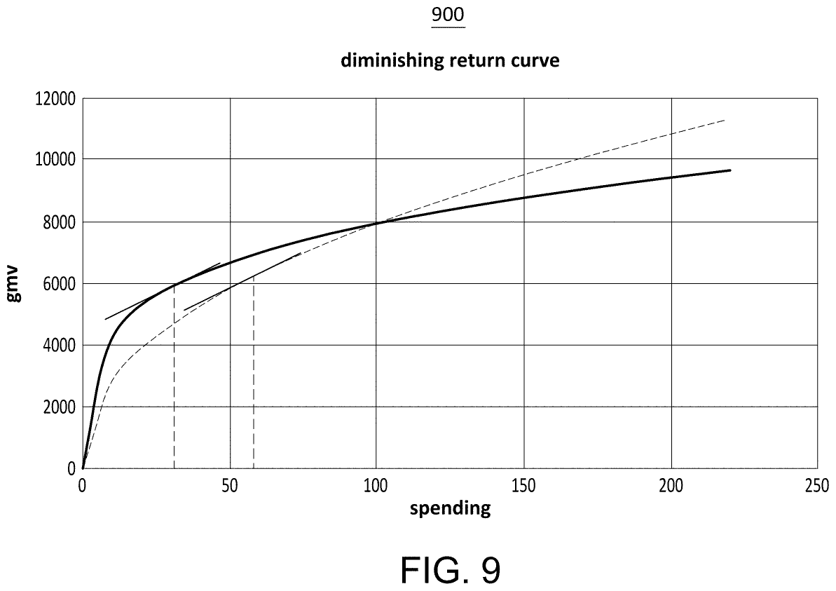

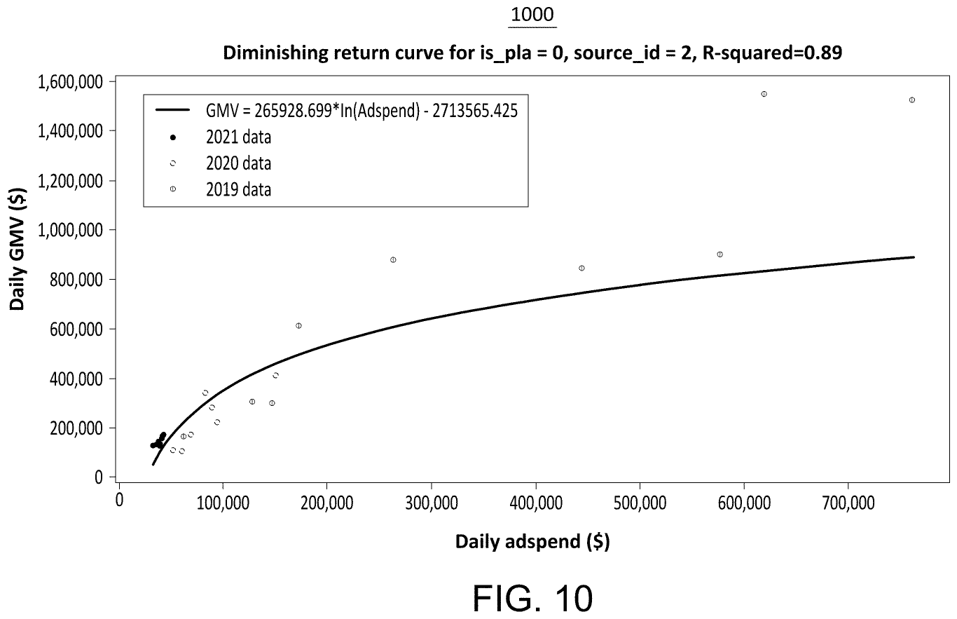

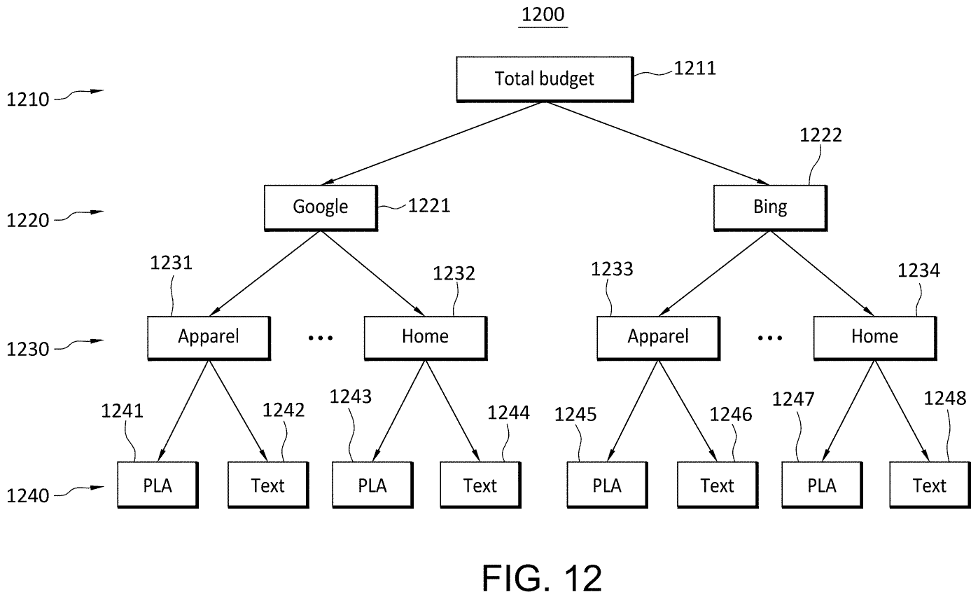

In several embodiments, method 800 further optionally can include a block 810 of generating, using a machine-learning model, the respective performance curve for each respective node of nodes of a layered allocation tree based on the historical search engine marketing performance data. In some embodiments, the machine-learning model can be a non-linear regression model, and in other embodiments, the machine-learning model can be another suitable model. The respective performance curve can be similar or identical to the performance curves shown in FIGS. 9 and 10. The layered allocation tree can be similar or identical to the layered allocation tree shown in FIG. 12 and described below.

Jumping ahead in the drawings, FIG. 12 illustrates an exemplary layered allocation tree 1200. Layered allocation tree 1200 is merely exemplary, and embodiments of the layered allocation tree are not limited to the embodiments presented herein. The layered allocation tree can be employed in many different embodiments or examples not specifically depicted or described herein. In some embodiments, as shown in FIG. 12, layered allocation tree 1200 can include a root layer 1210, a first layer 1220 for search engine types, a second layer 1230 for product divisions, and/or a third layer 1240 for advertisement types. Root layer 1210 can include a node 1211 that represents the total budget across all categories. First layer 1220 can include nodes, such as nodes 1221 and 1222 for different search engine types. For example, node 1221 can be for the Google search engine, and node 1222 can be for the Bing search engine. Second layer 1230 can include nodes, such as nodes 1231-1234, which can represent product divisions. For example, nodes 1231 and 1233 can represent the Apparel division, but node 1231 can be under the Google search engine (node 1221), and node 1233 can be under the Bing search engine (node 1222). Third layer 1240 can include nodes, such as nodes 1241-1248, which can represent advertisement types, such as PLAs and textual advertisements, and which can be under each node of second layer 1230 for product divisions of layered allocation tree 1200. For example, nodes 1241, 1243, 1245, and 1247 can be PLAs, each under a different product division, and nodes 1242, 1244, 1246, and 1248 can be textual ads, each under a different product division. For example, node 1241 can represent PLAs for the Apparel product division on the Google search engine. In many embodiments, the performance curves can be generated for each node (e.g., 1211, 1221-1222, 1231-1234, 1241-1248) of layered allocation tree 1200.

Turning back in the drawings, FIG. 9 illustrates a graph 900 showing two different exemplary performance curves. The performance curves are diminishing return curves, showing that the ROAS decreases as spending increases. The ROAS is the same for the two curves in FIG. 9 at a spending level of $100 (i.e., where the curves cross). However, the MROAS (i.e., slope of the curves) is not equalized at this spending level. Any example of equalized MROAS is shown for spending of about $30 for the solid curve and spending of about $60 for the dashed curve, as the slopes of the curves are the same at these points. For an MROAS at a spending level on the solid curve, a spending level can be determined on the dashed curve to equalized the MROAS.

Turning ahead in the drawings, FIG. 10 illustrates a graph 1000 showing a performance curve that was generated based on historical SEM performance data. In the example shown, the performance curve was generated using non-linear regression, such that the performance curve follows the following formula:

GMV=A*ln(Adspend)+B,

where GMV is the gross merchandise value, Adspend is the amount spend on SEM advertising, and A and B are derived parameters based on the historical performance data. In the case of the performance curve shown in FIG. 10, A is derived as 265928.699, and B is derived as −2713565.425. The goodness of the fit of the performance curve to the historical SEM performance data can be measured by the R-squared value, which generally has a value between 0 and 1, with higher values indicating that the derived curve fits the data better. In the case of the performance curve shown in FIG. 10, the R-squared value is 0.89.

In some embodiments, when the R-squared value of the respective performance curve of one of the nodes (e.g., node 1211, 1221-1222, 1231-1234, or 1241-1248) is below a fit threshold value, the respective performance curve for the one of the nodes can be generated as two or more piecewise sections of performance curves. The fit threshold value can be 0.2, 0.3, 0.4, 0.5, 0.6, 0.7, 0.8, or another suitable value. When the R-squared value is below the threshold, the fit of the performance curve to the data can be suboptimal, which can be addressed by using multiple performance curves across the data. For example, for ad spend between 0 and $200,000, a first performance curve can be generated, and for ad spend greater than $200,000, a second performance curve can be generated, such that there are two performance curves, each having a better fit for the data than the original single performance curve.

In many embodiments, when an R-squared value of the respective performance curve of a leaf node (e.g., node 1241-1248) of the nodes is below the fit threshold value, the respective performance curve can be generated for the leaf node based on subtracting the respective performance curves for each of one of more sister nodes of the leaf node from the respective performance curve of a parent of the leaf node. For example, if the performance curve for node 1241 is fitting poorly, such that its R-squared value is below the fit threshold, the performance curve for node 1241 can be calculated by using the performance curve for the parent node of node 1241, namely node 1231, and subtracting out the performance curve of any sister nodes under the parent node, namely node 1242.

Returning to FIG. 8, in a number of embodiments, method 800 additionally can include a block 815 of receiving a total budget amount for a predetermined time period. The predetermined time period can be a day, a set number of days, a week, a month, a year, or another suitable time period. The total budget amount can be input through ad spend selection button 561 (FIG. 5) or another suitable way. Block 815 can be similar or identical to block 410 (FIG. 4).

In several embodiments, method 800 can include a block 820 of determining a respective spend amount for the predetermined time period for each respective node of the nodes of the layered allocation tree based a marginal return on advertisement spend (MROAS) value and the respective performance curve for the each respective node. For example, an initial MROAS value can be selected, such as 3.0. This MROAS value can be used for each of the performance curves for each of the nodes of layered allocation tree 1200 (FIG. 12) to determine what ad spend value results in that MROAS value. This ad spend determination can be performed for each node (e.g., 1211, 1221-1222, 1231-1234, 1241-1248). The ad spend amount of each non-leaf node of layered allocation tree 1200 is the sum of the ad spend of the child nodes of that node.

In a number of embodiments, method 800 further can include a block 825 of determining a total spend amount based on the respective spend amounts of the nodes of the layered allocation tree. For example, the ad spend amount for node 1211 determined in block 820 can be used as the total spend amount, which can be equal to the sum of the nodes in each individual layer. For example, the total spend amount is the sum of the ad spend for nodes 1221 and 1222. Similarly, the total spend amount is the sum of the ad spend for nodes 1231-1234. Likewise, the total spend amount is the sum of the ad spend for nodes 1241-1248.

In several embodiments, when the total spend amount is not within a threshold value of the total budget amount, method 800 can proceed from block 825 to a block 830 of iteratively adjusting the MROAS value to re-determine the respective spend amounts for the nodes and re-determine the total spend amount, based on the MROAS value, as adjusted, until the total spend amount is within the threshold value. The MROAS value can thus be adjusted to a different value, after which blocks 820 and 825 can be repeated based on the newly adjusted MROAS value. If the total spend amount is higher than the total budget amount, and the difference between the total spend amount and the total budget amount is not within a threshold value, then the MROAS can be increased, which will result in the total spend amount decreasing, due to the nature of the diminishing return curves that model the ROAS. If the total spend amount is lower than the total budget amount, and the difference between the total spend amount and the total budget amount is not within a threshold value, then the MROAS can be decreased, which will result in the total spend amount increasing. In some embodiments, the threshold amount can be 0, 1 cent, 5 cents, 10 cents, 50 cents, 1 dollar, 5 dollars, 10 dollars, 50 dollars, 100 dollars, 500 dollars, 1,000 dollars, 5,000 dollars, 10,000 dollars, or another suitable value. The threshold amount can be used to allow the iteration to stop when the total spend is close enough to the total budget amount, which can be configurable by the user or predetermined in performance bidding system 300 (FIG. 3). When the threshold amount is 0, the iteration continues until the total spend amount equals the total budget amount.

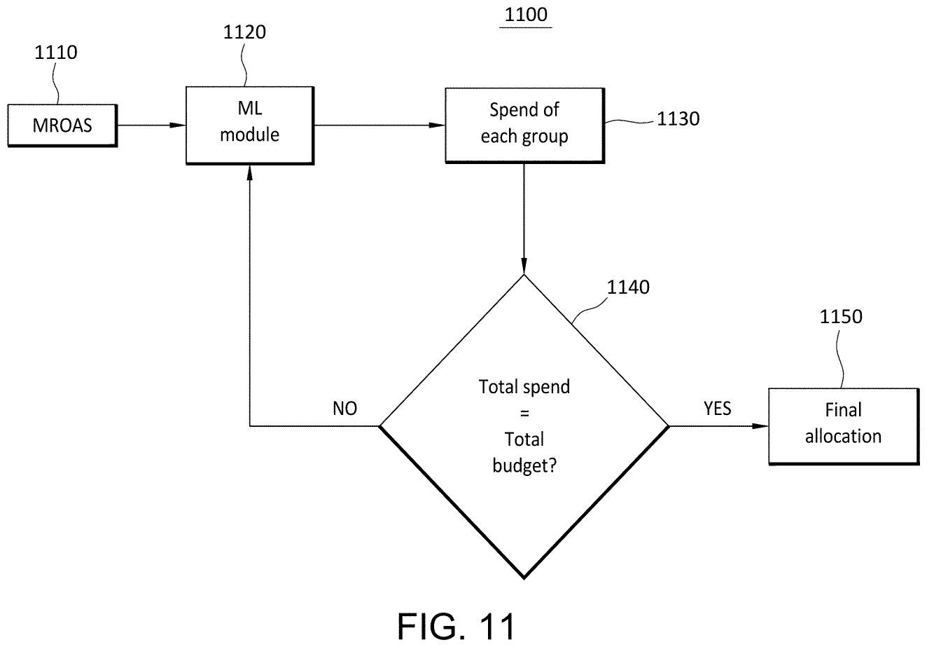

In many embodiments, the MROAS value can be adjusted using a binary search to more quickly identify a MROAS value that results in a total spend amount that is within the threshold amount of the total budget. After the MROAS has been adjusted, the flow of method 800 can return to block 820 to perform blocks 820 and 825 again using the newly adjusted MROAS. A flow chart showing the process of iterating through the MROAS values is shown in FIG. 11, described below.

Jumping ahead in the drawings, FIG. 11 illustrates a flow chart for a method 1100. In some embodiments, method 1100 can be a method of iterating through MROAS values to find a total spend that is within the threshold amount of the total budget amount. Method 1100 is merely exemplary and is not limited to the embodiments presented herein. Method 1100 can be employed in many different embodiments or examples not specifically depicted or described herein. In some embodiments, the procedures, the processes, and/or the activities of method 1100 can be performed in the order presented. In other embodiments, the procedures, the processes, and/or the activities of method 1100 can be performed in any suitable order. In still other embodiments, one or more of the procedures, the processes, and/or the activities of method 1100 can be combined or skipped.

In many embodiments, method 1100 can begin with a block 1110 of inputting an initial MROAS value into a machine learning process. The machine learning process can perform a block 1120 of determining the spend amount for each group (e.g., node) based on the MROAS value. The machine learning system can perform a block 1130 of outputting the spend amount for each group. Method 1100 can continue with a block 1140 of comparing the total spend amount to the total budget amount. If the total spend amount is not equal to or within the threshold value of the total budget amount, then the flow of method 1100 returns to block 1120 with a new MROAS value. Otherwise, if the total spend amount is equal to or within the threshold value of the total budget amount, then the flow of method 1100 can proceed to a block 1150 of outputting the final allocation.

Returning in the drawings to FIG. 8, in a number of embodiments, when the total spend amount is within the threshold value, method 800 can proceed from block 825 to a block 835 of outputting an allocation for the predetermined time period. The allocation can include the respective spend amounts for the nodes of the layered allocation tree (e.g., 1200 (FIG. 12)). In many embodiments, this allocation can be used by bid system 303 (FIG. 3) and/or pacing system 304 (FIG. 3). In addition or alternatively, the allocation can be output to a user of performance bidding system 300 (FIG. 3), such as on the graphical user interface provided by user interface system 301 (FIG. 3).

In some embodiments, the respective spend amount for the predetermined time period for the each respective node can be constrained between a respective lower bound and a respective upper bound based on a respective previous allocation amount for the each respective node for a previous time period. For example, the respective lower bound can be approximately 20%, or another suitable percentage, of the respective previous allocation amount, and/or the respective upper bound can be approximately 200%, or another suitable percentage, of the respective previous allocation amount. In many embodiments, the previous time period can have a duration that is the same duration as the predetermine time period. For example, if the predetermined time period is for the following month, then the previous time period can be for the previous month. The constraints on the spend amounts for each node can prevent the spending from increasing or decreasing too dramatically in any particular category, which can prevent noise or other anomalies in the historical SEM performance data from altering the allocation for any particular node to an undue degree.

Returning to FIG. 3, in several embodiments, user interface system 301 can at least partially perform block 405 (FIG. 4) of providing a graphical user interface comprising input fields and output fields, block 410 (FIG. 4) of receiving a total allocation amount for a predetermined time period in an allocation amount input field of the input fields of the graphical user interface, block 415 (FIG. 4) of receiving a performance objective in a performance objective input field of the input fields of the graphical user interface, block 420 (FIG. 4) of receiving a division granularity selection in one or more division granularity fields of the input fields of the graphical user interface, block 440 (FIG. 4) of displaying the daily allocation forecast and the one or more performance forecasts in the output fields of the graphical user interface, block 815 (FIG. 8) of receiving a total budget amount for a predetermined time period, and/or block 1150 (FIG. 11) of outputting the final allocation.

In several embodiments, allocation system 302 can at least partially perform block 425 (FIG. 4) of automatically generating an allocation of the total allocation amount among combinations selected from multiple advertisement types and multiple search engines based at least in part on the total allocation amount and the performance objective according to allocation balancing rules, block 430 (FIG. 4) of automatically generating one or more performance forecasts based on the allocation, block 435 (FIG. 4) of automatically generating a daily allocation forecast across the predetermined time period based on the allocation, block 805 (FIG. 8) of obtaining historical search engine marketing performance data, block 810 (FIG. 8) of generating, using a machine-learning model, the respective performance curve for each respective node of nodes of a layered allocation tree based on the historical search engine marketing performance data, block 820 (FIG. 8) of determining a respective spend amount for the predetermined time period for each respective node of the nodes of the layered allocation tree based a marginal return on advertisement spend (MROAS) value and the respective performance curve for the each respective node, block 825 (FIG. 8) of determining a total spend amount based on the respective spend amounts of the nodes of the layered allocation tree, block 830 (FIG. 8) of iteratively adjusting the MROAS value to re-determine the respective spend amounts for the nodes and re-determine the total spend amount, block 835 (FIG. 8) of outputting an allocation for the predetermined time period, block 1110 (FIG. 11) of inputting an initial MROAS value into a machine learning process, block 1120 (FIG. 11) of determining the spend amount for each group based on the MROAS value, block 1130 (FIG. 11) of outputting the spend amount for each group, block 1140 (FIG. 11) of comparing the total spend amount to the total budget amount, and/or block 1150 (FIG. 11) of outputting the final allocation.

In a number of embodiments, bid system 303 can at least partially perform block 445 (FIG. 4) of automatically bidding for each of the multiple advertisement types at each of the multiple search engines based at least in part on the daily allocation forecast.

In several embodiments, pacing system 304 can at least partially perform block 450

(FIG. 4) of estimating a predicted total amount consumed for a day based on actual amounts consumed during a first portion of the day and historical amounts consumed, and/or block 455 (FIG. 4) of adjusting bidding for a remainder of the day based on the predicted total amount consumed for the day and an allotment for the day in the daily allocation forecast.

In many embodiments, the techniques described herein can provide several technological improvements. In some embodiments, the techniques described herein can provide a bidding platform with controls for multiple objectives. For example, in a number of embodiments, the bidding platform can control for both spending and performance objectives in a selected division and/or subdivision in a manner that equalizes performance within each combination of search engine, ad type, and subdivision. In many embodiments, the techniques described herein can beneficially predict forecasts based on historical information and can adjust based on current information that describes current conditions.

In many embodiments, the techniques described herein can beneficially allow a user (e.g., 350 (FIG. 3)), such as a marketing manager, to set ad spend at a division or subdivision level, and receive a forecast of how the ad spend specified will impact performance for a selected performance objective (e.g., KPI) in the upcoming week. In several embodiments, the performance objective can be selected from a list of possible performance objectives, such as ROAS, CPOAS, CAC, GMV, etc. In various embodiments, the techniques described herein can customize (e.g., optimize) the returns under the performance objective over a time, such as a seven-day rolling model.

In a number of embodiments, the techniques described herein can advantageously allow for automatic pacing of spending to adjust to current conditions, as ad bidding in SEM can involve spending uncertainty. In a number of embodiments, the techniques described herein can be performance automatically without intervention from manual engineering or data scientists.

In many embodiments, the techniques described herein can be used continuously at a scale that cannot be handled using manual techniques. For example, the number of PLA ads and textual (keyword) ads at any one time can exceed 100 million.

In many embodiments, the techniques described herein can provide a non-conventional improvement over the heuristic rules that conventionally have been used in determining budget allocation. For example, many conventional methods determine a new budget allocation based on the previous budget allocation, with heuristic rules defining some adjustments. These approaches do not optimally allocate the budget amount. By contrast, the techniques described herein can optimally allocate the budget using machine learning and a robust layered allocation method based on MROAS.

In a number of embodiments, the techniques described herein can solve a technical problem that arises only within the realm of computer networks, as SEM bidding does not exist outside the realm of computer networks. Moreover, the techniques described herein can solve a technical problem that cannot be solved outside the context of computer networks. Specifically, the techniques described herein cannot be used outside the context of computer networks, in view of a lack of data, and because the user interface that is part of the techniques described herein would not exist.

Various embodiments can include a system including one or more processors and one or more non-transitory computer-readable media storing computing instructions configured to run on the one more processors and perform certain acts. The acts can include providing a graphical user interface including input fields and output fields. The acts also can include receiving a total allocation amount for a predetermined time period in an allocation amount input field of the input fields of the graphical user interface. The allocation amount input field can constrain the total allocation amount between a lower bound and an upper bound based on a previous allocation amount. The acts additionally can include receiving a performance objective in a performance objective input field of the input fields of the graphical user interface. The performance objective input field can provide a set of options for selection of the performance objective. The acts further can include automatically generating an allocation of the total allocation amount among combinations selected from multiple advertisement types and multiple search engines based at least in part on the total allocation amount and the performance objective according to allocation balancing rules. The acts additionally can include automatically generating one or more performance forecasts based on the allocation. The acts further can include automatically generating a daily allocation forecast across the predetermined time period based on the allocation. The acts additionally can include displaying the daily allocation forecast and the one or more performance forecasts in the output fields of the graphical user interface. The acts further can include, after receiving an approval, automatically bidding for each of the multiple advertisement types at each of the multiple search engines based at least in part on the daily allocation forecast.

A number of embodiments can include a method being implemented via execution of computing instructions configured to run at one or more processors and stored at one or more non-transitory computer-readable media. The method can include providing a graphical user interface including input fields and output fields. The method also can include receiving a total allocation amount for a predetermined time period in an allocation amount input field of the input fields of the graphical user interface. The allocation amount input field can constrain the total allocation amount between a lower bound and an upper bound based on a previous allocation amount. The method additionally can include receiving a performance objective in a performance objective input field of the input fields of the graphical user interface. The performance objective input field can provide a set of options for selection of the performance objective. The method further can include automatically generating an allocation of the total allocation amount among combinations selected from multiple advertisement types and multiple search engines based at least in part on the total allocation amount and the performance objective according to allocation balancing rules. The method additionally can include automatically generating one or more performance forecasts based on the allocation. The method further can include automatically generating a daily allocation forecast across the predetermined time period based on the allocation. The method additionally can include displaying the daily allocation forecast and the one or more performance forecasts in the output fields of the graphical user interface. The method further can include, after receiving an approval, automatically bidding for each of the multiple advertisement types at each of the multiple search engines based at least in part on the daily allocation forecast.

Various embodiments can include a system including one or more processors and one or more non-transitory computer-readable media storing computing instructions that, when executed on the one or more processors, cause the one or more processors to perform certain acts. The acts can include receiving a total budget amount for a predetermined time period. The acts also can include determining a respective spend amount for the predetermined time period for each respective node of nodes of a layered allocation tree based a marginal return on advertisement spend (MROAS) value and a respective performance curve for the each respective node. The acts additionally can include determining a total spend amount based on the respective spend amounts of the nodes of the layered allocation tree. The acts further can include, when the total spend amount is not within a threshold value of the total budget amount, iteratively adjusting the MROAS value to re-determine the respective spend amounts for the nodes and re-determine the total spend amount, based on the MROAS value, as adjusted, until the total spend amount is within the threshold value. The acts additionally can include, when the total spend amount is within the threshold value, outputting an allocation for the predetermined time period. The allocation can include the respective spend amounts for the nodes of the layered allocation tree.

A number of embodiments can include a method being implemented via execution of computing instructions configured to run at one or more processors and stored at one or more non-transitory computer-readable media. The method can include receiving a total budget amount for a predetermined time period. The method also can include determining a respective spend amount for the predetermined time period for each respective node of nodes of a layered allocation tree based a marginal return on advertisement spend (MROAS) value and a respective performance curve for the each respective node. The method additionally can include determining a total spend amount based on the respective spend amounts of the nodes of the layered allocation tree. The method further can include, when the total spend amount is not within a threshold value of the total budget amount, iteratively adjusting the MROAS value to re-determine the respective spend amounts for the nodes and re-determine the total spend amount, based on the MROAS value, as adjusted, until the total spend amount is within the threshold value. The method additionally can include, when the total spend amount is within the threshold value, outputting an allocation for the predetermined time period. The allocation can include the respective spend amounts for the nodes of the layered allocation tree.

Although providing a bidding platform with controls for multiple objectives and/or allocating search engine marking budget based on marginal return on advertisement spend has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-12 may be modified, and that the foregoing discussion of certain of these embodiments does not necessarily represent a complete description of all possible embodiments. For example, one or more of the procedures, processes, or activities of FIGS. 4, 8, and 11 may include different procedures, processes, and/or activities and be performed by many different modules, in many different orders, and/or one or more of the procedures, processes, or activities of FIGS. 4, 8, and 12 may include one or more of the procedures, processes, or activities of another different one of FIGS. 4, 8, and 12. As another example, the systems within performance bidding system 300 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
receiving a total budget amount for a predetermined time period;
determining a respective spend amount for the predetermined time period for each respective node of nodes of a layered allocation tree based a marginal return on advertisement spend (MROAS) value and a respective performance curve for the each respective node;
determining a total spend amount based on the respective spend amounts of the nodes of the layered allocation tree;
when the total spend amount is not within a threshold value of the total budget amount, iteratively adjusting the MROAS value to re-determine the respective spend amounts for the nodes and re-determine the total spend amount, based on the MROAS value, as adjusted, until the total spend amount is within the threshold value; and
when the total spend amount is within the threshold value, outputting an allocation for the predetermined time period, wherein the allocation comprises the respective spend amounts for the nodes of the layered allocation tree.

2. The system of claim 1, wherein the computing instructions, when executed on the one or more processors, cause the one or more processors to perform, before determining the respective spend amount for the predetermined time period for the each respective node:
obtaining historical search engine marketing performance data; and
generating, using a machine-learning model, a respective performance curve for the each respective node of the nodes of the layered allocation tree based on the historical search engine marketing performance data.

3. The system of claim 2, wherein:
the machine-learning model is a non-linear regression model.

4. The system of claim 2, wherein generating the respective performance curve for the each respective node further comprises, when an R-squared value of the respective performance curve of one of the nodes is below a fit threshold value:
generating the respective performance curve for the one of the nodes as two or more piecewise sections of performance curves.

5. The system of claim 2, wherein generating the respective performance curve for the each respective node further comprises, when an R-squared value of the respective performance curve of a leaf node of the nodes is below a fit threshold value:
generating the respective performance curve for the leaf node based on subtracting the respective performance curves for each of one of more sister nodes of the leaf node from the respective performance curve of a parent of the leaf node.

6. The system of claim 1, wherein:
the respective spend amount for the predetermined time period for the each respective node is constrained between a respective lower bound and a respective upper bound based on a respective previous allocation amount for the each respective node for a previous time period.

7. The system of claim 6, wherein:
the respective lower bound is approximately 20% of the respective previous allocation amount; and
the respective upper bound is approximately 200% of the respective previous allocation amount.

8. The system of claim 1, wherein iteratively adjusting the MROAS value further comprises:
adjusting the MROAS value using a binary search.

9. The system of claim 1, wherein:
the layered allocation tree comprises a first layer for search engine types, a second layer for product divisions, and a third layer for advertisement types.

10. The system of claim 9, wherein:
the third layer for advertisement types of the layered allocation tree comprises respective nodes for PLAs and textual advertisements under each node of the second layer for product divisions of the layered allocation tree.

11. A method being implemented via execution of computing instructions configured to run at one or more processors and stored at one or more non-transitory computer-readable media, the method comprising:
receiving a total budget amount for a predetermined time period;
determining a respective spend amount for the predetermined time period for each respective node of nodes of a layered allocation tree based a marginal return on advertisement spend (MROAS) value and a respective performance curve for the each respective node;
determining a total spend amount based on the respective spend amounts of the nodes of the layered allocation tree;
when the total spend amount is not within a threshold value of the total budget amount, iteratively adjusting the MROAS value to re-determine the respective spend amounts for the nodes and re-determine the total spend amount, based on the MROAS value, as adjusted, until the total spend amount is within the threshold value; and
when the total spend amount is within the threshold value, outputting an allocation for the predetermined time period, wherein the allocation comprises the respective spend amounts for the nodes of the layered allocation tree.

12. The method of claim 11, further comprising, before determining the respective spend amount for the predetermined time period for the each respective node:
obtaining historical search engine marketing performance data; and
generating, using a machine-learning model, the respective performance curve for the each respective node of the nodes of the layered allocation tree based on the historical search engine marketing performance data.

13. The method of claim 12, wherein:
the machine-learning model is a non-linear regression model.

14. The method of claim 12, wherein generating the respective performance curve for the each respective node further comprises, when an R-squared value of the respective performance curve of one of the nodes is below a threshold value:
generating the respective performance curve for the one of the nodes as two or more piecewise sections of performance curves.

15. The method of claim 12, wherein generating the respective performance curve for the each respective node further comprises, when an R-squared value of the respective performance curve of a leaf node of the nodes is below a threshold value:
generating the respective performance curve for the leaf node based on subtracting the respective performance curves for each of one of more sister nodes of the leaf node from the respective performance curve of a parent of the leaf node.

16. The method of claim 11, wherein:
the respective spend amount for the predetermined time period for the each respective node is constrained between a respective lower bound and a respective upper bound based on a respective previous allocation amount for the each respective node for a previous time period.

17. The method of claim 16, wherein:
the respective lower bound is approximately 20% of the respective previous allocation amount; and
the respective upper bound is approximately 200% of the respective previous allocation amount.

18. The method of claim 11, wherein iteratively adjusting the MROAS value further comprises:
adjusting the MROAS value using a binary search.

19. The method of claim 11, wherein:
the layered allocation tree comprises a first layer for search engine types, a second layer for product divisions, and a third layer for advertisement types.

20. The method of claim 19, wherein:
the third layer for advertisement types of the layered allocation tree comprises respective nodes for PLAs and textual advertisements under each node of the second layer for product divisions of the layered allocation tree.
